(19) United States
(12) Patent Application Publication
(10) Pub. No.: US 2020/0272553 A1
(43) Pub. Date: Aug. 27, 2020

(54) CONFIGURABLE SYSTEM FOR INTERACTION WITH SYSTEM OR PROCESSOR STATES IN DEVELOPMENT TOOLS

(71) Applicant: NXP USA, Inc., AUSTIN, TX (US)

(72) Inventors: Dragos Miloiu, Prahova (RO); Daniel Dumitru Popa, Bucharest (RO)

(21) Appl. No.: 16/401,576

(22) Filed: May 2, 2019

(30) Foreign Application Priority Data
Feb. 26, 2019 (RO) A 2019 00129

(51) Int. Cl. G06F 11/36; G06F 11/14

(52) U.S. Cl. CPC G06F 11/362; G06F 11/1402; G06F 11/3664; G06F 11/3692

(57) ABSTRACT

A system that enables efficient analysis of system states or snapshots is provided. Embodiments collect data that describes a current status of a software application being debugged, along with the current state of the environment in which the application is executed, as a system state. Embodiments simplify and accelerate debugging by performing automatic comparison of different states or snapshots as triggered by user or system selection, highlighting the differences. Embodiments further enable rule definition to ignore data in the comparison that is not relevant for a current use case; customizing information being saved as part of system snapshots; and, for common application scenarios, predefined configuration templates to control the type and amount of information being saved and compared.

### BACKGROUND

### Field

This disclosure relates generally to debugging applications executing on embedded systems, and more specifically, providing tools to define components of a system's state to store and compare during debugging operations.

### Related Art

An integrated development environment (IDE) provides a suite of facilities for development of software. Typical IDEs include facilities such as a source code editor, build automation tools, debugging tools, and trace and profiling tools. A goal of an IDE is to provide a single user interface for the variety of components used for authoring, modifying, compiling, deploying, and debugging software. Further, the IDE presents the components as a cohesive unit, thereby not only improving productivity, but also improving learning time for developers.

In traditional software debugging, it can be useful to compare a current system snapshot with a previous snapshot to pinpoint a difference that has caused an incorrect behavior. For desktop applications, this can mean comparing current values of variables with a previous set of variable values. But for embedded applications, the scenario is significantly more complex in that there may be other aspects of the system state that cause the incorrect behavior. For example, comparisons may be needed of register values of a variety of hardware blocks (e.g., ethernet, DMA, and the like), cache content, and memory locations, to name a few.

Given the large number of possible aspects of the system state that need to be reviewed for embedded applications, manual inspection of the system resource values is too time consuming and likely to have errors. It is therefore desirable to have a mechanism by which portions of interest of the system state can be easily defined and refined, while system state snapshots can be quickly compared to determine a source of a fault.

### BRIEF DESCRIPTION OF THE DRAWINGS

The present invention may be better understood, and its numerous objects, features, and advantages made apparent to those skilled in the art by referencing the accompanying drawings.

FIG. 1 is a simplified block diagram illustrating an example development system incorporating an integrated development environment (IDE) configurable to use with embodiments of the present invention.

FIG. 2 is a simplified flow diagram illustrating an example of a process in which a system state configuration is defined for the data to save as part of a system state, in accord with embodiments of the present invention.

FIG. 3 is a simplified flow diagram illustrating an example of a process for analyzing system states in accord with embodiments of the present invention.

FIG. 4 is a simplified block diagram of a computer system suitable for implementing aspects of the present invention.

FIG. 5 is a simplified block diagram of a network architecture suitable for implementing aspects of the present invention.

The use of the same reference symbols in different drawings indicates identical items unless otherwise noted. The figures are not necessarily drawn to scale.

### DETAILED DESCRIPTION

A system is provided that enables efficient analysis of system states or snapshots. Embodiments of the present invention collect data that describes a current status of a software application being debugged, along with the current state of the environment in which the application is executed, as a system state. Embodiments can simplify and accelerate debugging by performing automatic comparison of different states or snapshots as triggered by user or system selection, highlighting the differences. Embodiments further enable rule definition to ignore data in the comparison that is not relevant for a current use case; customizing information being saved as part of system snapshots; and, for common application scenarios, predefined configuration templates to control the type and amount of information being saved and compared.

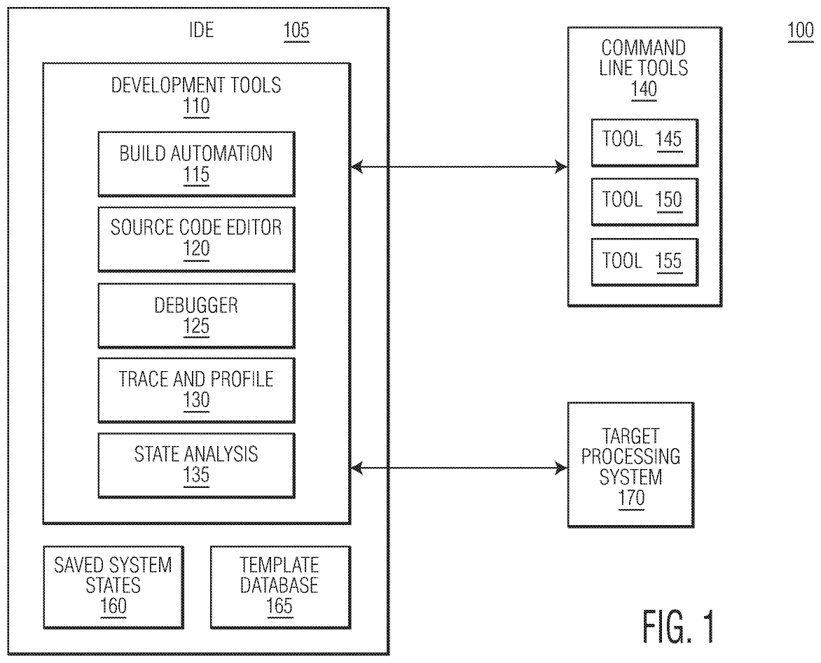

FIG. 1 is a simplified block diagram illustrating an example development system incorporating an integrated development environment (IDE) configurable to use with embodiments of the present invention. Development system 100 includes an integrated development environment 105 communicatively coupled to one or more sets of command line tools 140 that are external to integrated development environment 105 and a target processing system 170 being analyzed by the IDE. Integrated development environment 105 can provide a suite of development tools 110 to aid in the development of software by a user. Development tools 110 provided by integrated development environment 105 can include, for example, one or more build automation tools 115, source code editors 120, debuggers 125, trace and profiling 130, and state analysis tools 135.

Build automation tools 115 can also include a build manager that coordinates tasks related to building executable versions of a code being developed in the IDE. In order to provide executable versions of code for various different processing environments, the source code may be subject to pre-compilation processing, then processed by a compiler or assembler depending on the nature of the code, and linked to libraries or other object code. In addition, information regarding the nature of the target processing environment that ultimately will be executing the code (e.g., target processing system 170) can determine those command line tools used to generate the executable version.

In traditional IDEs, many, if not all, of the tools necessary to generating executable versions of the code are incorporated in the IDE itself. In such cases, any output generated by the tools is provided directly to the IDE and is handled by the IDE—either displaying the information or relating the information to portions of the code (e.g., in the source code editor). If an IDE interacts with tools outside the integrated development environment, those tools provide their output as an output string. Those output strings can include error information that is needed by the IDE to present to the developer for response. Thus, a facility to read and interpret the output strings from the tools and provide interpreted information to the IDE is used, which can then relate that information to the developer.

FIG. 1 provides an example of a system where the tools used by the IDE are external to the integrated development environment in a set of command line tools 140. Build automation tools 115 uses information from the project to select a set of command line tools 140 to build the executable version of the code for a target processing environment.

In addition to the build automation tools, IDE 105 can include one or more source code editors 120. Source code editors can provide a variety of functionality, depending upon the needs of the environment. Such tools can include features to simplify and speed up typing of source code. In addition, a source code editor 120 can provide access to other portions of the IDE, such as compilers and interpreters in build automation 115, debugger 125, trace and profiler 130, or other programs associated with the software development process (e.g., state analysis tools 135). Integrating debugger 125 into IDE 105 allows for control of the debug process in the other portions of the IDE. For example, breakpoints can be set in the source code editor, while visual rendering of steps can be provided in the IDE graphical interface.

Embedded systems provide additional challenges for debugging of software executing on those systems. For example, there can be real-time constraints on when data is received or sent, timing of interrupts, and the like. Traditional debugging techniques, such as breakpoints or changing the code to print out state information cannot be used because they can change the timing and therefore behavior of the program. In addition, program flow can be controlled by asynchronous and external events, such as inputs from sensors and other peripherals. Real-time behavior of the program cannot be understood simply by looking at control flow in source code. Further, there can be a large number of system resources impacting the system state at any time, contributing to the complexity of effectively and efficiently debugging an embedded system.

State analysis tools 135 are provided by embodiments of the present invention to aid in the debug process of complex systems, such as embedded systems. A system state is a collection of data that describes (a) a current state of the software or application being debugged, and (b) a current state of the environment in which the software or application is executed, including both the hardware and software environment surrounding the application. Included in a system's state are data provided by resources associated with the system. Resources can be application related, hardware related, and operating system related. Application-related resources can include, for example, variable values, stack crawl, and available threads. Hardware-related resources can include, for example, register values for hardware blocks, individual registers, memory locations, and cache contents. Operating system-related resources can include, for example, a list of running processes, and other operating system statistics that can influence application behavior.

In embodiments of the present invention, state analysis tools 130 provide an ability to define a state configuration used in gathering a current system state for analysis. The state configuration can include a list of resources that will be saved as part of the system state and a listing of rules defining what to ignore from the collected data (e.g., data not relevant for a current use case). Each state configuration defined by a user can be provided a unique identifier and stored by the IDE system in, for example, a saved system states memory 160. Through the use of state configurations, embodiments of the present invention enable customization of information that is to be saved as part of system snapshots, thereby allowing a user to focus on an area of the system believed to be causing an undesirable condition.

In addition, templates can provide predefined configurations to control the IDE and the debugger. For example, predefined system state definitions can be provided to control the type and amount of information being saved. Different applications can suggest different initial templates. Likewise, different SoCs executing the application can implicate different registers and memory locations even for the same application. Templates can be stored in a template database 165 accessible by state analysis tools 130.

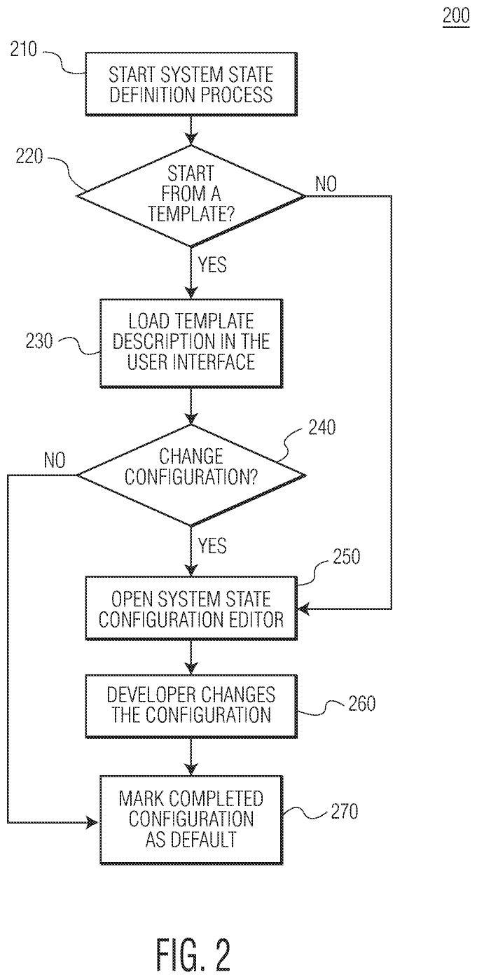

FIG. 2 is a simplified flow diagram illustrating an example of a process 200 in which a developer can define a system state configuration for the data to save as part of a system state, in accord with embodiments of the present invention. The developer can use the tool to begin a process of defining data of interest that will be saved in the system state (210). This process can begin within the IDE. As part of the process, the system can query the developer as to whether the system state definition should start with a configuration template (220). The developer can then choose a configuration template saved in a template database 165. Such templates can be provided by the provider of the IDE or the state analysis tools, and, as discussed above, can be application specific or SoC specific, or a combination. Definitions provided in a configuration template result in a high-level view of system state in select portions of the SoC in light of the application under analysis. For example, if an ethernet-related application is being analyzed, then ethernet registers and the ethernet controller will be included as resource targets of the template. But different SoCs may have different ethernet controllers, so the template will be configured in light of that information as well. Templates allow for a targeted approach to system analysis during debug, which provides a starting point for additional narrowing of the scope of areas under analysis.

If the developer elects to start defining the system state configuration in light of a configuration template, then system state analysis tool will load the configuration template and provide the description of the template in a user interface (230). The system then can give the developer an option to change the configuration from the default provided in the template (240). A developer could elect to do this, for example, if they are aware of where in the system current errors are being generated, and therefore they want to focus on that area to improve data collection and data comparison efficiency. If the developer chooses to change the configuration, then the system opens a system state configuration editor (250). The developer can then change the system state configuration (260). Such configuration changes can be made by the user selecting from a list of available resources to include in the system state. In addition, the user can define rules to exclude information from the system state, as desired. If the developer opted not to start from a template, the configuration editor can then be provided to the user to input their own configuration. Once the configuration editing process is completed, the new configuration can be saved in template database 165 and can be marked as the default system state configuration for the current system analysis session or as a default system state configuration for the SoC/application combination (270).

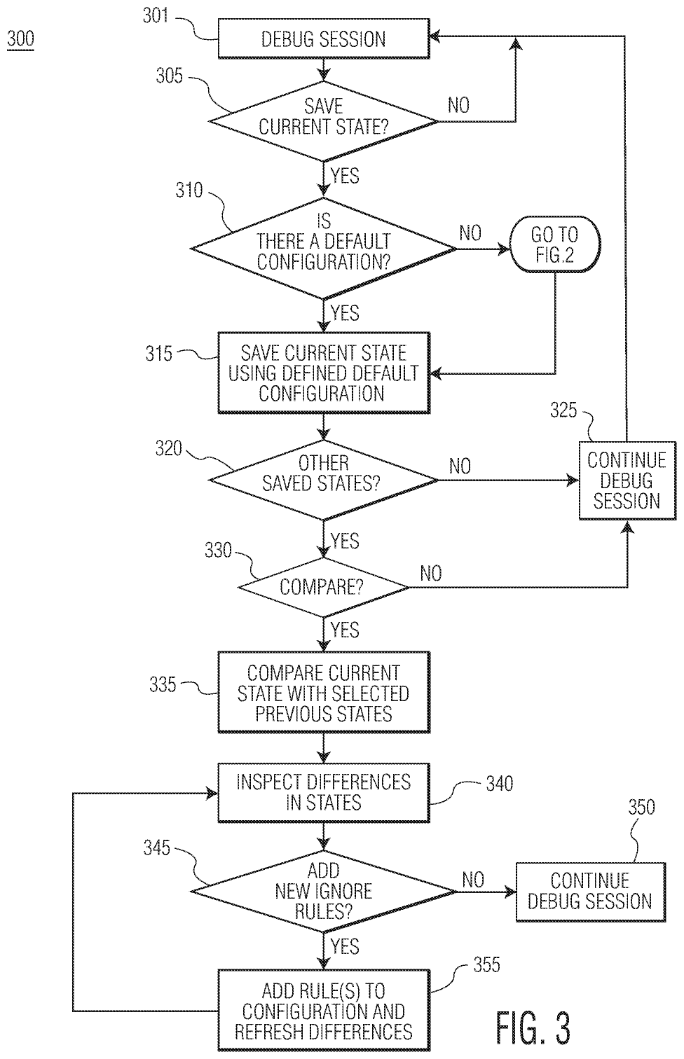

FIG. 3 is a simplified flow diagram illustrating an example of a process 300 for analyzing system states in accord with embodiments of the present invention. During a debug session (301), a determination is made as to whether to save the current state of the system (305). Such a state can be saved to provide a working baseline of the system from which to compare error condition states or can be compared against an earlier snapshot. The determination to save the current system state can be controlled either by the system state analysis tool or by the user. For example, the system state analysis tool can be configured to save a new system state automatically at a pre-defined trigger point (e.g., after each step, breakpoint hit, or resume/stop). Alternatively, a manual save can be preferred due to, for example, the size of system states being large due to execution on a complex system.

If a default system state configuration has not been defined (310), the system can give the operator an opportunity to define the default system state configuration (e.g., per the flow illustrated in FIG. 2). If the default system state configuration has been defined, then the current state can be identified, and the system will save the current state in, for example, saved system states area 160 of the development environment memory (315).

In an alternative embodiment, the system state configuration can be controlled by the system state analysis tool depending on previous iterations. For example, in embedded systems, the program being analyzed typically repeats in a loop. Assuming that the default system state configuration template includes states that are no longer applicable when running in the loop, saving of those states may be discarded by the tool since they are no longer applicable for the current context (e.g., for bootup where states referring to initializations are no longer applicable since the system is running).

A determination can then be made if other system states have been previously saved (320). If not, then the debug session can continue until another opportunity for saving a system state occurs (325). If a previous system state has been saved, then an option for performing a comparison between system states can be given (330). If the operator does not wish to compare the current system state to a previous system state, then the debug session can continue until another opportunity for saving a system state occurs (325).

If the operator does wish to compare the current system state to a previous system state, then a comparison is performed (335). State analysis tool 130 compares the stored values of the current system state against those in the previous system state and provides an indication to the user of where the differences lie. As discussed above, analysis of the stored state information is performed in light of the stored rules in the defined state, which can selectively exclude information from the analysis. The state analysis tool can then provide graphical information to the user through the IDE of those locations in which system state has changed between the state snapshots and the user can inspect the differences (340). The information can be shown in differing levels of granularity, and the user can zoom in on those areas of interest. During the course of debugging, the user can opt to add additional rules to ignore areas that are determined not to be the cause of the erroneous behavior (345). The rules can be added to the current configuration and the differences can be refreshed in light of the new rules (355). This allows for masking of the available data to more clearly see where differences occur and the nature of those differences. Once all rules have been added for the present comparison, the debug session can continue (350). In this manner, the cause of the erroneous behavior can be quickly and efficiently located.

Through the use of a state analysis tool of embodiments of the present invention, it should be appreciated that the debug process is customizable and dynamic. Definitions can be made for what is saved and when it is saved, as opposed to a static approach in which an entire system dump file is generated when an application crashes. In addition, the integration of the state analysis tool in the integrated development environment allows for the use of the tool at any time during the functioning of an application, rather than a post mortem analysis.

By now it should be appreciated that there has been provided in one embodiment a method for debugging code executing in a target processing environment. The method includes storing a first set of information associated with a pre-selected set of system resources from the target processing environment at a first instance, gathering a second set of information associated with the pre-selected set of system resources from the target processing environment at a second instance, masking the first and second sets of information in light of one or more pre-determined rules, comparing the masked second set of information with the masked first set of information, and displaying an indication of the differences.

In one aspect of the above embodiment, the first and second sets of information are provided by a debugger executing in association with the target processing environment. In another aspect of the above embodiment, the method includes pre-selecting the pre-selected set of system resources using a template, where the template identifies resources of interest in the target processing environment. In a further aspect, the method includes modifying the identified resources of interest in the template to pre-select the pre-selected set of system resources.

In another aspect of the above embodiment, the set of system resources includes one or more of application-related resources, hardware-related resources, and operating system-related resources. In a further aspect, the application-related resources include one or more of variable values, stack crawl values, and available threads. In another further aspect, the hardware-related resources include one or more of register values for identified hardware blocks, registers, memory locations, and cache locations. In still another further aspect, the operating system-related resources include one or more of a list of executing processors and operating system statistics.

In another aspect of the above embodiment, the method includes updating the pre-determined rules in response to the comparing. In a further aspect, the method further includes masking the first and second sets of information in light of the updated predetermined rules, comparing the updated masked second set of information with the updated masked first set of information for second differences, and displaying an indication of the second differences. In another further aspect, the method further includes gathering a third set of information associated with the pre-selected set of system resources from the target processing environment at a third instance, masking the third set of information and one or more of the first and second sets of information in light of the updated pre-determined rules, comparing the masked third set of information with the masked one or more of the first and second sets of information for third differences, and displaying an indication of the third differences. In another aspect of the above embodiment, the method further includes storing a state configuration including a list of the pre-selected set of system resources and a list of the pre-determined rules, and accessing the state configuration for the pre-selected set of system resources and the pre-determined rules.

Another embodiment provides a development environment system that includes a target processing system and an analysis system communicatively coupled to the target processing system. The target processing system includes a processor and hardware resources, and is configured to execute one or more program threads, and execute a debugger to analyze the one or more program threads. The analysis system is configured to provide an integrated development environment (IDE). The IDE is configured to request a first set of information associated with a pre-selected set of system resources from the target processing system at a first instance, request a second set of information associated with the pre-selected set of system resources from the target processing system at a second instance, mask the first and second sets of information in light of one or more pre-determined rules, compare the masked second set of information with the masked first set of information for differences, and display an indication of the differences.

In one aspect of the above embodiment, the analysis system further includes a memory storing a template. The template identifies resources of interest in the target processing environment to define the pre-selected set of system resources. In a further aspect, the analysis system is further configured to modify the identified resources of interest in the template to further define the pre-selected set of system resources.

In another aspect of the above embodiment, the analysis system is further configured to update the pre-determined rules in response to the comparing. In a further aspect, the analysis system is further configured to mask the first and second sets of information in light of the updated pre-determined rules, compare the updated masked second set of information with the updated masked first set of information for second differences, and display an indication of the second differences. In another further aspect, the analysis system is further configured to request a third set of information associated with the pre-selected set of system resources from the target processing environment at a third instance, mask the third set of information and one or more of the first and second sets of information in light of the updated pre-determined rules, compare the masked third set of information with the masked one or more of the first and second sets of information for third differences, and display an indication of the third differences.

An Example Computing and Network Environment

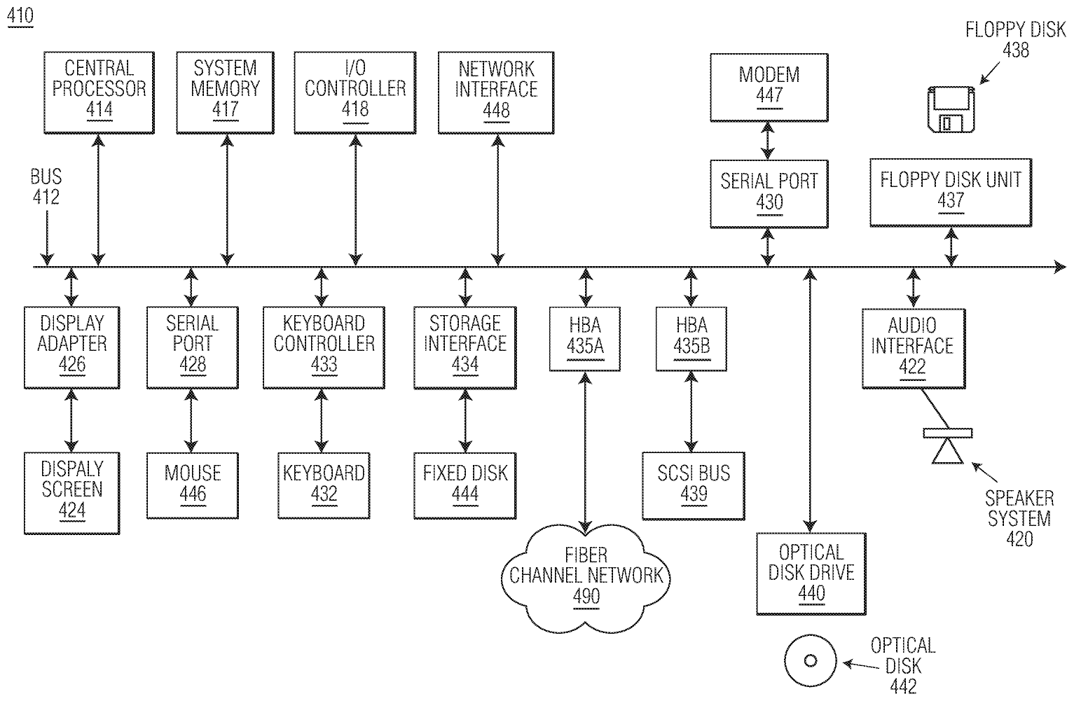

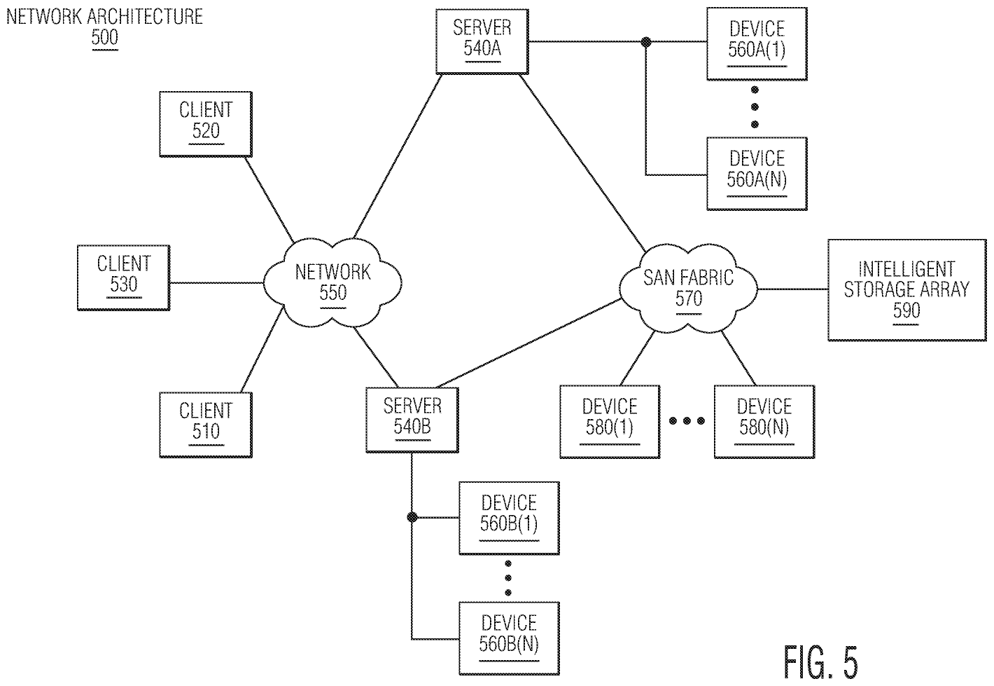

As shown above, the present invention can be implemented using a variety of computer systems and networks. An example of one such computing and network environment is described below with reference to FIGS. 4 and 5.

FIG. 4 depicts a block diagram of a computer system 410 suitable for implementing aspects of the present invention. Computer system 410 includes a bus 412 which interconnects major subsystems of computer system 410, such as a central processor 414, a system memory 417 (typically RAM, but which may also include ROM, flash RAM, or the like), an input/output controller 418, an external audio device, such as a speaker system 420 via an audio output interface 422, an external device, such as a display screen 424 via display adapter 426, serial ports 428 and 430, a keyboard 432 (interfaced with a keyboard controller 433), a storage interface 434, a floppy disk drive 437 operative to receive a floppy disk 438, a host bus adapter (HBA) interface card 435A operative to connect with a Fibre Channel network 490, a host bus adapter (HBA) interface card 435B operative to connect to a SCSI bus 439, and an optical disk drive 440 operative to receive an optical disk 442. Also included are a mouse 446 (or other point-and-click device, coupled to bus 412 via serial port 428), a modem 447 (coupled to bus 412 via serial port 430), and a network interface 448 (coupled directly to bus 412).

Bus 412 allows data communication between central processor 414 and system memory 417, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 410 are generally stored on and accessed via a computer-readable medium, such as a hard disk drive (e.g., fixed disk 444), an optical drive (e.g., optical drive 440), a floppy disk unit 437, or other storage medium. Additionally, applications can be in the form of electronic signals modulated in accordance with the application and data communication technology when accessed via network modem 447 or network interface 448.

Storage interface 434, as with the other storage interfaces of computer system 410, can connect to a standard computer-readable medium for storage and/or retrieval of information, such as a fixed disk drive 444. Fixed disk drive 444 may be a part of computer system 410 or may be separate and accessed through other interface systems. Modem 447 may provide a direct connection to a remote server via a telephone link or to the Internet via an internet service provider (ISP). Network interface 448 may provide a direct connection to a remote server via a direct network link to the Internet via a POP (point of presence). Network interface 448 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 4 need not be present to practice the present invention. The devices and subsystems can be interconnected in different ways from that shown in FIG. 4. The operation of a computer system such as that shown in FIG. 4 is readily known in the art and is not discussed in detail in this application. Code to implement the present invention can be stored in computer-readable storage media such as one or more of system memory 417, fixed disk 444, optical disk 442, or floppy disk 438.

FIG. 5 is a block diagram depicting a network architecture 500 in which client computer systems 510, 520 and 530, as well as storage servers 540A and 540B (any of which can be implemented using computer system 410), are coupled to a network 550. Storage server 540A is further depicted as having storage devices 560A(1)-(N) directly attached, and storage server 540B is depicted with storage devices 560B(1)-(N) directly attached. Storage servers 540A and 540B are also connected to a SAN fabric 570, although connection to a storage area network is not required for operation of the invention. SAN fabric 570 supports access to storage devices 580(1)-(N) by storage servers 540A and 540B, and so by client systems 510, 520 and 530 via network 550. Intelligent storage array 590 is also shown as an example of a specific storage device accessible via SAN fabric 570.

With reference to computer system 410, modem 447, network interface 448 or some other method can be used to provide connectivity from each of client computer systems 510, 520 and 530 to network 550. Client systems 510, 520 and 530 are able to access information on storage server 540A or 540B using, for example, a web browser or other client software (not shown). Such a client allows client systems 510, 520 and 530 to access data hosted by storage server 540A or 540B or one of storage devices 560A(1)-(N), 560B(1)-(N), 580(1)-(N) or intelligent storage array 590. FIG. 5 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 410). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future. Non-transitory computer-readable storage media include all computer-readable media, except for a transitory, propagating signal.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Consequently, the invention is intended to be limited only by the scope of the appended claims, giving full cognizance to equivalents in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for debugging code executing in a target processing environment, the method comprising:
storing a first set of information associated with a pre-selected set of system resources from the target processing environment at a first instance;
gathering a second set of information associated with the pre-selected set of system resources from the target processing environment at a second instance;
masking the first and second sets of information in light of one or more pre-determined rules;
comparing the masked second set of information with the masked first set of information for differences; and
displaying an indication of the differences.

2. The method of claim 1 wherein the first and second sets of information are provided by a debugger executing in association with the target processing environment.

3. The method of claim 1 further comprising:
pre-selecting the pre-selected set of system resources using a template, wherein the template identifies resources of interest in the target processing environment.

4. The method of claim 3 further comprising:
modifying the identified resources of interest in the template to pre-select the pre-selected set of system resources.

5. The method of claim 1 wherein the set of system resources comprises one or more of:
application-related resources;
hardware-related resources; and
operating system-related resources.

6. The method of claim 5 wherein the application-related resources comprise one or more of:
variable values;
stack crawl values; and
available threads.

7. The method of claim 5 wherein the hardware-related resources comprise one or more of:
register values for identified hardware blocks;
registers;
memory locations; and
cache contents.

8. The method of claim 5 wherein the operating system-related resources comprise one or more of:
a list of executing processes; and
operating system statistics.

9. The method of claim 1 further comprising:
updating the pre-determined rules in response to said comparing.

10. The method of claim 9 further comprising:
masking the first and second sets of information in light of the updated pre-determined rules;
comparing the updated masked second set of information with the updated masked first set of information for second differences; and
displaying an indication of the second differences.

11. The method of claim 9 further comprising:
gathering a third set of information associated with the pre-selected set of system resources from the target processing environment at a third instance;
masking the third set of information and one or more of the first and second sets of information in light of the updated pre-determined rules;
comparing the masked third set of information with the masked one or more of the first and second sets of information for third differences; and
displaying an indication of the third differences.

12. The method of claim 1 further comprising:
storing a state configuration comprising a list of the pre-selected set of system resources and a list of the pre-determined rules; and
accessing the state configuration for the pre-selected set of system resources and the pre-determined rules.

13. A development environment system comprising:
a target processing system comprising a processor and hardware resources, and configured to
execute one or more program threads, and
execute a debugger to analyze the one or more program threads; and
an analysis system, communicatively coupled to the target processing system, configured to provide an integrated development environment, wherein the integrated development environment is configured to
request a first set of information associated with a pre-selected set of system resources from the target processing system at a first instance,
request a second set of information associated with the pre-selected set of system resources from the target processing system at a second instance,
mask the first and second sets of information in light of one or more pre-determined rules,
compare the masked second set of information with the masked first set of information for differences, and
display an indication of the differences.

14. The development environment system of claim 13, wherein the analysis system further comprises:
a memory storing a template, wherein the template identifies resources of interest in the target processing environment to define the pre-selected set of system resources.

15. The development environment system of claim 14, wherein the analysis system is further configured to modify the identified resources of interest in the template to further define the pre-selected set of system resources.

16. The development environment system of claim 13, wherein the analysis system is further configured to update the pre-determined rules in response to said comparing.

17. The development environment of claim 16, wherein the analysis system is further configured to:
mask the first and second sets of information in light of the updated pre-determined rules;
compare the updated masked second set of information with the updated masked first set of information for second differences; and
display an indication of the second differences.

18. The development environment of claim 16, wherein the analysis system is further configured to:
request a third set of information associated with the pre-selected set of system resources from the target processing environment at a third instance;
mask the third set of information and one or more of the first and second sets of information in light of the updated pre-determined rules;
compare the masked third set of information with the masked one or more of the first and second sets of information for third differences; and
display an indication of the third differences.
